(19) United States
(12) Patent Application Publication
(10) Pub. No.: US 2020/0261902 A1
(43) Pub. Date: Aug. 20, 2020

(54) SYSTEMS AND METHODS FOR NESTING FILTERED PIPETTE TIPS TO REDUCE STORAGE SPACE AND PLASTIC WASTE

(71) Applicant: Scientific Specialties, Incorporated, Lodi, CA (US)

(72) Inventor: Kenneth R. Hovatter, Acampo, CA (US)

(21) Appl. No.: 16/281,008

(22) Filed: Feb. 20, 2019

(51) Int. Cl. B01L 3/02; B01L 9/00

(52) U.S. Cl. CPC B01L 3/022; B01L 3/0275; B01L 3/0289; B01L 9/54

(57) ABSTRACT

Systems and methods for nesting refill filtered pipette tips to reduce storage space and plastic waste are provided herein. Embodiments include a lower filtered refill wafer comprising a lower plurality of refill filtered pipette tips in a nested filtered pipette tip rack, the lower filtered refill wafer comprising the lower plurality of refill filtered pipette tips having holes between top portions of the lower plurality of refill filtered pipette tips. Various embodiments further include an upper filtered refill wafer comprising an upper plurality of refill filtered pipette tips nested into the holes between the top portions of the lower plurality of refill filtered pipette tips, the nesting of the upper filtered refill wafer thereby reducing storage space for the nested filtered pipette tip rack compared with storage space for a filtered pipette tip rack that is not nested.

### FIELD OF THE PRESENT INVENTION

The present technology relates generally to nesting filtered pipette tips and more specifically, but not by limitation, nesting filtered pipette tips for reducing storage space and plastic waste.

### SUMMARY

According to some embodiments a method for nesting refill filtered pipette tips to reduce storage space and plastic waste includes: (a) loading a lower filtered refill wafer comprising a lower plurality of refill filtered pipette tips into a nested filtered pipette tip rack so that the lower plurality of refill filtered pipette tips are easily loadable onto a pipette, the lower filtered refill wafer comprising the lower plurality of refill filtered pipette tips having holes between top portions of the lower plurality of refill filtered pipette tips; and (b) nesting an upper filtered refill wafer comprising an upper plurality of refill filtered pipette tips into the holes between the top portions of the lower plurality of refill filtered pipette tips, the nesting of the upper filtered refill wafer resulting in bottom portions of the upper plurality of refill filtered pipette tips being nested in the holes between the top portions of the lower plurality of refill filtered pipette tips thereby reducing storage space for the nested filtered pipette tip rack compared with storage space for a filtered pipette tip rack that is not nested.

In various embodiments the lower filtered refill wafer comprising the lower plurality of refill filtered pipette tips has 9 Millimeter (mm) spacing between each of the lower plurality of refill filtered pipette tips thereby allowing the lower filtered refill wafer to be compatible with a microtiter plate with 9 mm well center-to-center spacing; and the upper filtered refill wafer comprising the upper plurality of refill filtered pipette tips has 9 mm spacing between each of the upper plurality of refill filtered pipette tips thereby allowing the upper filtered refill wafer to be compatible with a microtiter plate with 9 mm well center-to-center spacing.

In some embodiments the holes between the top portions of the lower plurality of refill filtered pipette tips are between 3 and 5 Millimeters (mm) in diameter.

In various embodiments the lower plurality of refill filtered pipette tips of the lower filtered refill wafer and the upper plurality of refill filtered pipette tips of the upper filtered refill wafer have a same pipette volume.

In some embodiments the same pipette volume is at least one of 5 Microliters (μl), 10 μl, 15 μl, 20 μl, 50 μl, 100 μl, 200 μl, 500 μl, and 1000 μl.

According to various embodiments a method for nesting refill filtered pipette tips to reduce storage space and plastic waste includes: (a) loading a lower filtered refill wafer comprising a lower plurality of refill filtered pipette tips into a nested filtered pipette tip rack so that the lower plurality of refill filtered pipette tips are easily loadable onto a pipette, the lower filtered refill wafer comprising the lower plurality of refill filtered pipette tips having holes between top portions of the lower plurality of refill filtered pipette tips; (b) aligning an upper filtered refill wafer comprising an upper plurality of refill filtered pipette tips in a same configuration as the lower filtered refill wafer comprising the lower plurality of refill filtered pipette tips; (c) rotating the upper filtered refill wafer comprising the upper plurality of refill filtered pipette tips one-hundred-and-eighty-degrees (180°) relative to the upper filtered refill wafer after the aligning of the upper filtered refill wafer and before loading the upper filtered refill wafer comprising the upper plurality of refill filtered pipette tips into the nested filtered pipette tip rack; and (d) nesting the upper filtered refill wafer comprising the upper plurality of refill filtered pipette tips into the holes between the top portions of the lower plurality of refill filtered pipette tips, the nesting of the upper filtered refill wafer resulting in bottom portions of the upper plurality of refill filtered pipette tips being nested in the holes between the top portions of the lower plurality of refill filtered pipette tips thereby reducing storage space for the nested filtered pipette tip rack.

According to some embodiments a system for nesting refill filtered pipette tips to reduce storage space and plastic waste includes: a lower filtered refill wafer comprising a lower plurality of refill filtered pipette tips in a nested filtered pipette tip rack with the lower plurality of refill filtered pipette tips being easily loadable onto a pipette, the lower filtered refill wafer comprising the lower plurality of refill filtered pipette tips having holes between top portions of the lower plurality of refill filtered pipette tips. In various embodiments, the system includes an upper filtered refill wafer comprising an upper plurality of refill filtered pipette tips nested into the holes between the top portions of the lower plurality of refill filtered pipette tips, the nesting of the upper filtered refill wafer resulting in bottom portions of the upper plurality of refill filtered pipette tips being nested in the holes between the top portions of the lower plurality of refill filtered pipette tips thereby reducing storage space for the nested filtered pipette tip rack compared with storage space for a filtered pipette tip rack that is not nested.

In various embodiments the lower filtered refill wafer comprising the lower plurality of refill filtered pipette tips having holes between top portions of the lower plurality of refill filtered pipette tips and the upper filtered refill wafer comprising an upper plurality of refill filtered pipette tips nested into the holes between the top portions of the lower plurality of refill filtered pipette tips comprise a nested filtered pipette tip stack.

In various embodiments the nested filtered pipette tip stack comprises a total of five filtered refill wafers. In some embodiments the nested filtered pipette tip stack comprises a total of ten filtered refill wafers.

In some embodiments the holes between the top portions of the lower plurality of refill filtered pipette tips are between 3 and 5 Millimeters (mm) in diameter.

The systems and methods provided herein can also be claimed in terms of means-plus-function and/or step-for-function arrangements. Also, methods can be encoded on computer readable media that can be executed by a processor to perform the method.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1A is a top view schematic diagram of an example non-filtered refill wafer with a plurality of refill non-filtered pipette tips for a nested non-filtered pipette tip rack.

FIG. 1B is a side view schematic diagram of an example stack of non-filtered refill wafers with a plurality of refill non-filtered pipette tips for a nested non-filtered pipette tip rack.

FIG. 1C is a transparent side view schematic diagram of example stack of non-filtered refill wafers with a plurality of refill non-filtered pipette tips for a nested non-filtered pipette tip rack.

FIG. 1D is a close-up transparent side view schematic diagram of example refill non-filtered pipette tips that are nested.

FIG. 2A is a top view schematic diagram of an example filtered refill wafer with a plurality of refill filtered pipette tips for a filtered pipette tip rack that is not nested.

FIG. 2B is a side view schematic diagram of an example stack of filtered refill wafers with a plurality of refill filtered pipette tips for a filtered pipette tip rack that is not nested.

FIG. 2C is a transparent side view schematic diagram of example stack of filtered refill wafers with a plurality of refill filtered pipette tips for a filtered pipette tip rack that is not nested.

FIG. 2D is a close-up transparent side view schematic diagram of example refill filtered pipette tips for that are not nested.

FIG. 3A is a top view schematic diagram of an example filtered refill wafer with a plurality of refill filtered pipette tips for a filtered pipette tip rack according to embodiments of the present technology.

FIG. 3B is a side view schematic diagram of an example stack of filtered refill wafers with a plurality of refill filtered pipette tips for a nested filtered pipette tip rack according to embodiments of the present technology.

FIG. 3C is a transparent side view schematic diagram of example stack of filtered refill wafers with a plurality of refill filtered pipette tips for a nested filtered pipette tip rack according to embodiments of the present technology.

FIG. 3D is a close-up transparent side view schematic diagram of example refill filtered pipette tips for a nested filtered pipette tip rack according to embodiments of the present technology.

FIG. 3E is a transparent side view schematic diagram of example stack of filtered refill wafers with a plurality of refill filtered pipette tips for a filtered pipette tip rack that is not nested.

FIG. 3F is a close-up transparent side view schematic diagram of example refill filtered pipette tips for a filtered pipette tip rack that is not nested.

FIG. 4 is another close-up transparent side view schematic diagram of example refill filtered pipette tips for a nested filtered pipette tip rack according to embodiments of the present technology.

FIG. 5 is an exemplary method for nesting refill filtered pipette tips to reduce storage space and plastic waste according to embodiments of the present technology.

FIG. 6 is another exemplary method for nesting refill filtered pipette tips to reduce storage space and plastic waste according to embodiments of the present technology.

FIG. 7 is a schematic diagram of an example computing device that can be used to implement aspects of the present technology according to various embodiments.

### DETAILED DESCRIPTION OF EXEMPLARY EMBODIMENTS

While this invention is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

According to various embodiments, pipette tips (non-filtered pipette tips and filtered pipette tips) are often loaded into a pipette tip rack that allows pipette tips to be easily loaded onto a pipette. A pipette tip rack generally has a base, a wafer, and a lid. A wafer is a support wafer comprising a plurality of pipette tips with the wafer being designed to reduce movement of the plurality of the pipette tips in the wafer and in the pipette tip rack to enable easy removal of the pipette tips. A stacked pipette tip rack generally has a stack of a plurality of wafers including at least an upper wafer and a lower wafer. A pipette tip stack generally has a plurality of wafers.

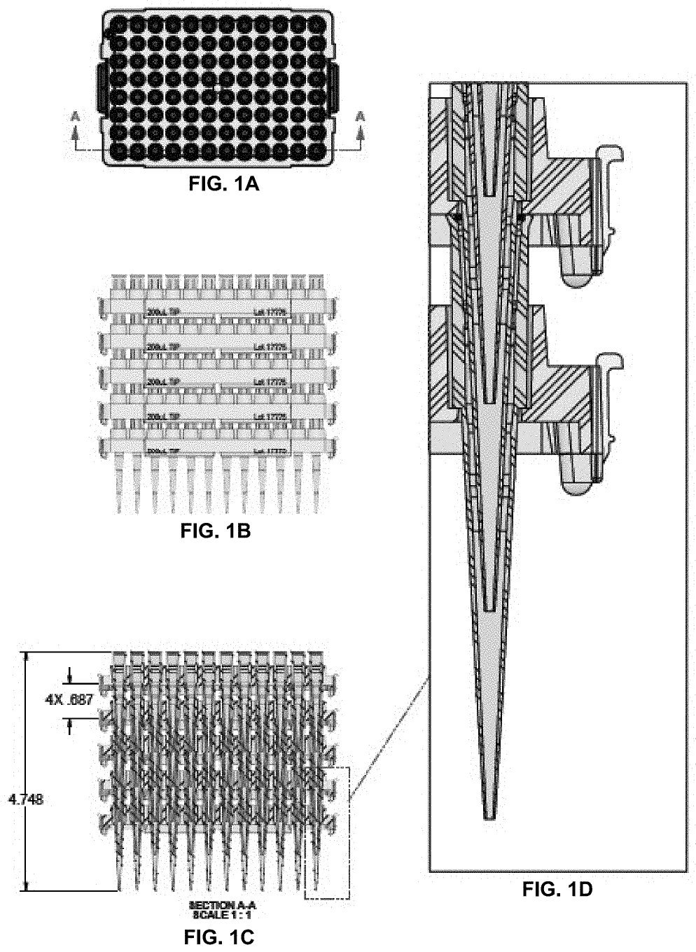

Generally after pipette tips in a pipette tip rack are used, the entire pipette tip rack, including the base, wafer, and lid are thrown away. To reduce waste, a refill concept may be used wherein individual wafers of non-filtered pipette tips are nested together and shipped in relatively efficient stacked pipette tip racks. For example, FIG. 1A, FIG. 1B, and FIG. 1C show non-filtered refill wafers with a plurality of refill non-filtered pipette tips for a nested non-filtered pipette tip stack. For instance, FIG. 1D shows a close-up transparent side view of refill non-filtered pipette tips that are nested.

Once all the non-filtered pipette tips in a wafer are used, the empty wafer that held the non-filtered pipette tips is disposed of and a refill wafer containing clean non-filtered pipette tips is removed from a nested non-filtered pipette tip stack and loaded into the an empty pipette tip rack. The nested non-filtered pipette tip stack has many advantages including reducing the required amount of storage space and waste. For example, storage space is reduced since the wafers of non-filtered pipette tips are nested. For instance, a nested stacked pipette tip rack comprising ten wafers generally fits into one third of the storage space that is necessary for ten individual non-filtered pipette tip racks that are not nested. Waste is reduced by not continually throwing out the pipette tip rack, base, and lid after each wafer is used. Variations of a nested refill system reduce waste and storage space for stacked non-filtered pipette tips.

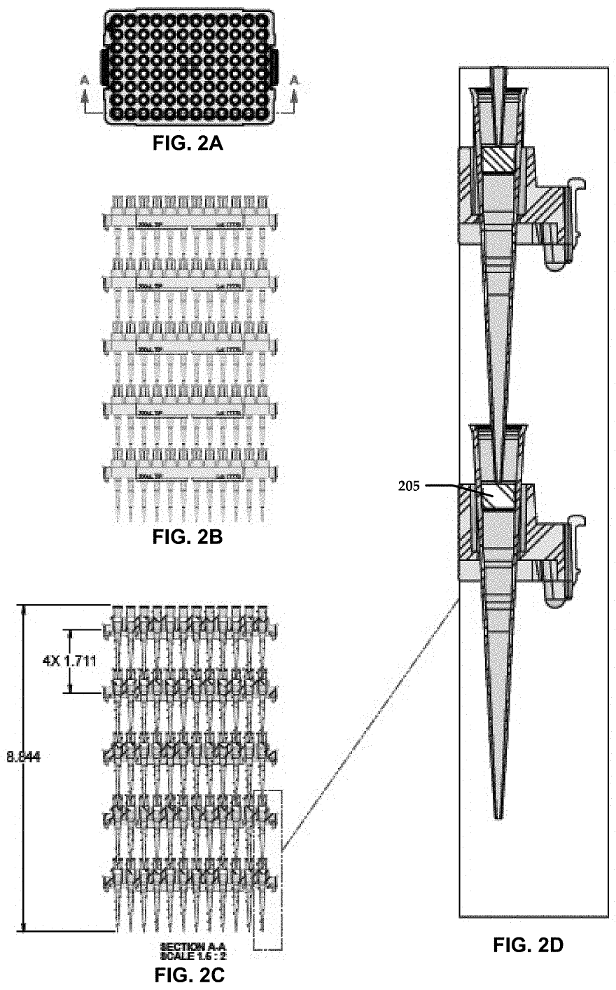

A nested refill system is not well suited for filtered pipette tips. Filtered pipette tips have a filter inside the top of the pipette tip that prevents contamination from a pipette to the filtered pipette tips below. The filter inside the top of the pipette tip prevents nesting of filtered pipette tips because the filter prevents the bottom of an upper pipette tip from nesting with a lower pipette tip. For example, FIG. 2A, FIG. 2B, FIG. 2C, and FIG. 2D show a stack of filtered refill wafers with a plurality of refill filtered pipette tips for a filtered pipette tip rack that is not nested. With this in mind, filtered pipette tip refill systems cannot use nesting to reduce the storage space necessary for stacked filtered tips. Instead, filtered refill wafers are individually wrapped that greatly increases the amount of space for filtered refill wafers because they are not nested.

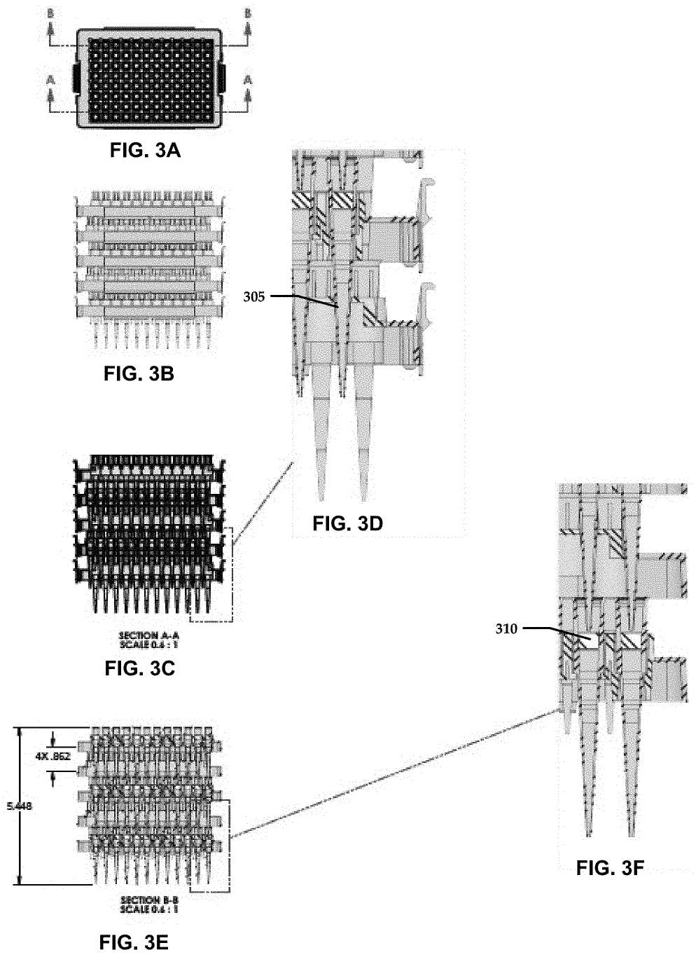

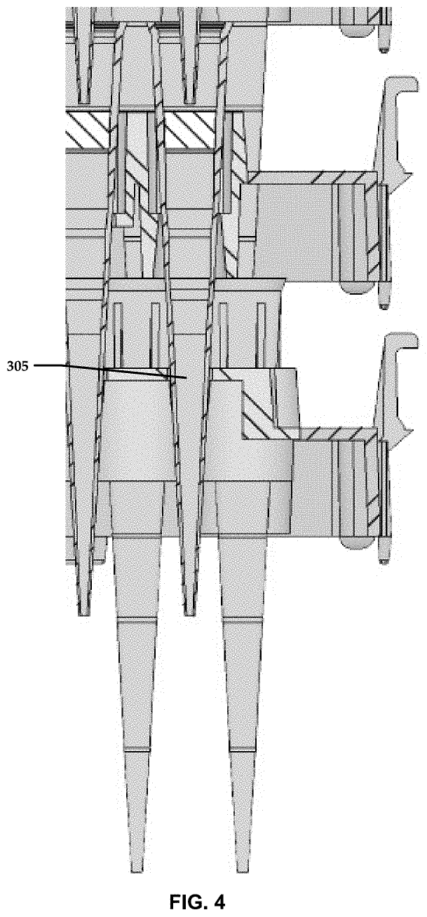

Embodiments of the present technology include systems and methods for nesting refill filtered pipette tips to reduce storage space and plastic waste. For example, FIG. 3C, FIG. 3D, and FIG. 4 show refill filtered pipette tips for a nested filtered pipette tip rack according to embodiments of the present technology.

Turning to the FIGS., FIG. 1A, FIG. 1B, FIG. 1C, and FIG. 1D show a non-filtered refill wafer with a plurality of refill non-filtered pipette tips. FIG. 1A is a top view schematic diagram of an example non-filtered refill wafer with a plurality of refill non-filtered pipette tips for a nested non-filtered pipette tip rack. FIG. 1A shows section A-A with the alignment of top for reference in FIG. 1C. Section A-A shows aligning an upper non-filtered refill wafer comprising an upper plurality of refill non-filtered pipette tips in a same configuration as the lower non-filtered refill wafer comprising the lower plurality of refill non-filtered pipette tips thereby allowing the nesting of the upper non-filtered refill wafer comprising the upper plurality of refill non-filtered pipette tips into the top portions of the lower plurality of refill non-filtered pipette tips.

FIG. 1B is a side view schematic diagram of an example stack of non-filtered refill wafers with a plurality of refill non-filtered pipette tips for a nested non-filtered pipette tip rack. FIG. 1B shows a nested non-filtered pipette tip stack with five non-filtered refill wafers thereby reducing storage space for a nested non-filtered pipette tip rack.

FIG. 1C is a transparent side view schematic diagram of example stack of non-filtered refill wafers with a plurality of refill non-filtered pipette tips for a nested non-filtered pipette tip rack. FIG. 1C shows reducing storage space for a nested non-filtered pipette tip stack including section A-A for reference from FIG. 1A. Section A-A shows aligning an upper non-filtered refill wafer comprising an upper plurality of refill non-filtered pipette tips in a same configuration as the lower non-filtered refill wafer comprising the lower plurality of refill non-filtered pipette tips thereby allowing the nesting of the upper non-filtered refill wafer comprising the upper plurality of refill non-filtered pipette tips into the top portions of the lower plurality of refill non-filtered pipette tips.

FIG. 1D is a close-up transparent side view schematic diagram of example refill non-filtered pipette tips that are nested. FIG. 1D shows four refill non-filtered pipette tips nested together thereby reducing storage space for a nested non-filtered pipette tip rack. FIG. 1D shows nesting of the upper refill non-filtered pipette tip into the top portion of the lower plurality of refill non-filtered pipette tip.

FIG. 2A is a top view schematic diagram of an example filtered refill wafer with a plurality of refill filtered pipette tips for a filtered pipette tip rack that is not nested. FIG. 2A shows section A-A for reference in FIG. 2C. Section A-A shows aligning an upper filtered refill wafer comprising an upper plurality of refill filtered pipette tips in a same configuration as the lower filtered refill wafer comprising the lower plurality of refill filtered pipette tips thereby preventing the nesting of the upper filtered refill wafer comprising the upper plurality of refill filtered pipette tips into the top portions of the lower plurality of refill filtered pipette tips. Significantly, filters of the lower plurality of refill filtered pipette tips prevents nesting of the upper plurality of refill filtered pipette tips into the top portions of the lower plurality of refill filtered pipette tips.

FIG. 2B is a side view schematic diagram of an example stack of filtered refill wafers with a plurality of refill filtered pipette tips for a filtered pipette tip rack that is not nested. FIG. 2B shows a filtered pipette tip rack with five filtered refill wafers that are not nested thereby increasing storage space for a filtered pipette tip rack that is not nested compared with a filtered pipette tip rack that is nested.

FIG. 2C is a transparent side view schematic diagram of example stack of filtered refill wafers with a plurality of refill filtered pipette tips for a filtered pipette tip rack that is not nested. FIG. 2C shows increasing storage space for a filtered pipette tip rack that is not nested compared with a filtered pipette tip rack that is nested including section A-A for reference from FIG. 2A. Section A-A shows aligning an upper filtered refill wafer comprising an upper plurality of refill filtered pipette tips in a same configuration as the lower filtered refill wafer comprising the lower plurality of refill filtered pipette tips thereby preventing the nesting of the upper filtered refill wafer comprising the upper plurality of refill filtered pipette tips into the top portions of the lower plurality of refill filtered pipette tips.

FIG. 2D is a close-up transparent side view schematic diagram of example refill filtered pipette tips that are not nested. FIG. 2D shows three refill filtered pipette tips that are not nested together thereby increasing storage space for a filtered pipette tip rack that is not nested compared with a filtered pipette tip rack that is nested. In more detail, filter 205 prevents nesting of the upper filtered refill wafer comprising the upper plurality of refill filtered pipette tips into the top portions of the lower plurality of refill filtered pipette tips.

FIG. 3A is a top view schematic diagram of an example filtered refill wafer with a plurality of refill filtered pipette tips for a filtered pipette tip rack according to embodiments of the present technology. FIG. 3A shows decreasing storage space for a filtered pipette tip rack that is nested compared with storage space for a filtered pipette tip rack that is not nested including section A-A for reference in FIG. 3C. Section A-A shows aligning for an upper filtered refill wafer comprising an upper plurality of refill filtered pipette tips nested into the holes between the top portions of the lower plurality of refill filtered pipette tips, the nesting of the upper filtered refill wafer resulting in bottom portions of the upper plurality of refill filtered pipette tips being nested in the holes between the top portions of the lower plurality of refill filtered pipette tips thereby reducing storage space for the nested filtered pipette tip rack compared with storage space for a filtered pipette tip rack that is not nested. In contrast, section B-B of FIG. 3A, for reference in FIG. 3E, shows aligning an upper filtered refill wafer comprising an upper plurality of refill filtered pipette tips in a same configuration as the lower filtered refill wafer comprising the lower plurality of refill filtered pipette tips thereby preventing the nesting of the upper filtered refill wafer comprising the upper plurality of refill filtered pipette tips into the top portions of the lower plurality of refill filtered pipette tips. For example, FIG. 3F shows filter 310 preventing the nesting of the upper plurality of refill filtered pipette tips into the top portions of the lower plurality of refill filtered pipette tips.

FIG. 3B is a side view schematic diagram of an example stack of filtered refill wafers with a plurality of refill filtered pipette tips for a nested filtered pipette tip rack according to embodiments of the present technology. FIG. 3B shows a filtered pipette tip rack with five filtered refill wafers that are nested thereby decreasing storage space for a filtered pipette tip rack that is nested compared with a filtered pipette tip rack that is not nested.

FIG. 3C is a transparent side view schematic diagram of example stack of filtered refill wafers with a plurality of refill filtered pipette tips for a nested filtered pipette tip rack according to embodiments of the present technology. FIG. 3C shows a filtered pipette tip rack with five filtered refill wafers that are nested thereby decreasing storage space for a filtered pipette tip rack that is nested compared with a filtered pipette tip rack that is not nested.

FIG. 3D is a close-up transparent side view schematic diagram of example refill filtered pipette tips for a nested filtered pipette tip rack according to embodiments of the present technology. FIG. 3D shows the upper plurality of refill filtered pipette tips being nested in the holes between the top portions of the lower plurality of refill filtered pipette tips thereby reducing storage space for the nested filtered pipette tip rack compared with storage space for a filtered pipette tip rack that is not nested. In more detail, FIG. 3D shows a hole 305 between a top portion of the lower plurality of refill filtered pipette tips. Significantly, nesting the upper plurality of refill filtered pipette tips in the holes (e.g., hole 305) between the top portions of the lower plurality of refill filtered pipette tips

FIG. 3E is a transparent side view schematic diagram of example stack of filtered refill wafers with a plurality of refill filtered pipette tips for a filtered pipette tip rack that is not nested. FIG. 3E shows increasing storage space for a filtered pipette tip rack that is not nested compared with a filtered pipette tip rack that is nested including section B-B for reference from FIG. 3A. Section B-B shows aligning an upper filtered refill wafer comprising an upper plurality of refill filtered pipette tips in a same configuration as the lower filtered refill wafer comprising the lower plurality of refill filtered pipette tips thereby preventing the nesting of the upper filtered refill wafer comprising the upper plurality of refill filtered pipette tips into the top portions of the lower plurality of refill filtered pipette tips.

FIG. 3F is a close-up transparent side view schematic diagram of example refill filtered pipette tips for a filtered pipette tip rack that is not nested. FIG. 3F shows increasing storage space for a filtered pipette tip rack that is not nested compared with a filtered pipette tip rack that is nested. In more detail, filter 310 preventing the nesting of the upper plurality of refill filtered pipette tips into the top portions of the lower plurality of refill filtered pipette tips. In contrast, FIG. 3D shows the upper plurality of refill filtered pipette tips being nested in the holes between the top portions of the lower plurality of refill filtered pipette tips.

FIG. 4 is another close-up transparent side view schematic diagram of example refill filtered pipette tips for a nested filtered pipette tip rack according to embodiments of the present technology. FIG. 4 shows decreasing storage space for a filtered pipette tip rack that is nested compared with a filtered pipette tip rack that is not nested. In more detail, FIG. 4 shows the upper plurality of refill filtered pipette tips being nested in the holes (e.g., hole 305) between the top portions of the lower plurality of refill filtered pipette tips.

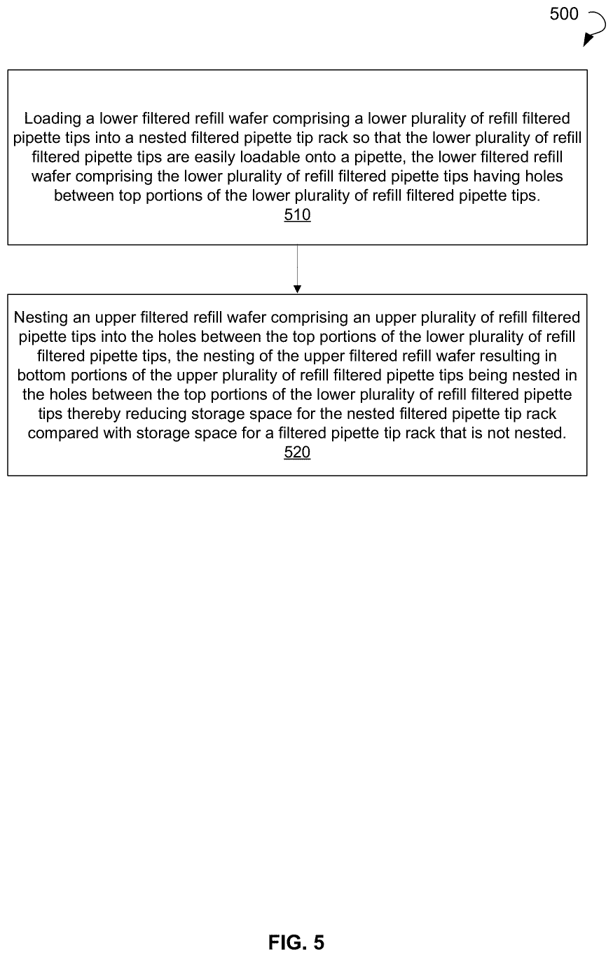

FIG. 5 is an exemplary method 500 for nesting refill filtered pipette tips to reduce storage space and plastic waste according to embodiments of the present technology. The exemplary method 500 for nesting refill filtered pipette tips to reduce storage space and plastic waste includes the following operations. Loading 510 a lower filtered refill wafer comprising a lower plurality of refill filtered pipette tips into a nested filtered pipette tip rack so that the lower plurality of refill filtered pipette tips are easily loadable onto a pipette, the lower filtered refill wafer comprising the lower plurality of refill filtered pipette tips having holes between top portions of the lower plurality of refill filtered pipette tips. The exemplary method 500 further includes nesting 520 an upper filtered refill wafer comprising an upper plurality of refill filtered pipette tips into the holes between the top portions of the lower plurality of refill filtered pipette tips, the nesting of the upper filtered refill wafer resulting in bottom portions of the upper plurality of refill filtered pipette tips being nested in the holes between the top portions of the lower plurality of refill filtered pipette tips thereby reducing storage space for the nested filtered pipette tip rack compared with storage space for a filtered pipette tip rack that is not nested.

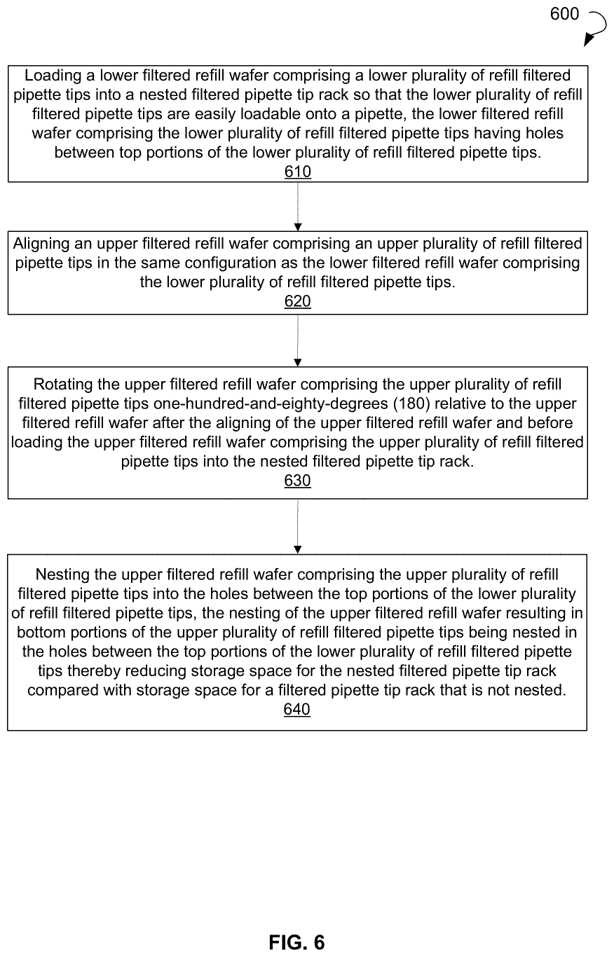

FIG. 6 is another exemplary method 600 for nesting refill filtered pipette tips to reduce storage space and plastic waste according to embodiments of the present technology. The exemplary method 600 for nesting refill filtered pipette tips to reduce storage space and plastic waste includes the following operations. The method 600 includes loading 610 a lower filtered refill wafer comprising a lower plurality of refill filtered pipette tips into a nested filtered pipette tip rack so that the lower plurality of refill filtered pipette tips are easily loadable onto a pipette, the lower filtered refill wafer comprising the lower plurality of refill filtered pipette tips having holes between top portions of the lower plurality of refill filtered pipette tips. The method 600 further includes aligning 620 an upper filtered refill wafer comprising an upper plurality of refill filtered pipette tips in a same configuration as the lower filtered refill wafer comprising the lower plurality of refill filtered pipette tips. The method 600 includes rotating 630 the upper filtered refill wafer comprising the upper plurality of refill filtered pipette tips one-hundred-and-eighty-degrees (180°) relative to the upper filtered refill wafer after the aligning of the upper filtered refill wafer and before loading the upper filtered refill wafer comprising the upper plurality of refill filtered pipette tips into the nested filtered pipette tip rack. The method 600 further includes nesting 640 the upper filtered refill wafer comprising the upper plurality of refill filtered pipette tips into the holes between the top portions of the lower plurality of refill filtered pipette tips, the nesting of the upper filtered refill wafer resulting in bottom portions of the upper plurality of refill filtered pipette tips being nested in the holes between the top portions of the lower plurality of refill filtered pipette tips thereby reducing storage space for the nested filtered pipette tip rack compared with storage space for a filtered pipette tip rack that is not nested.

In various embodiments of the method 600 the lower filtered refill wafer comprising the lower plurality of refill filtered pipette tips has 9 Millimeter (mm) spacing between each of the lower plurality of refill filtered pipette tips thereby allowing the lower filtered refill wafer to be compatible with a microtiter plate with 9 mm well center-to-center spacing; and the upper filtered refill wafer comprising the upper plurality of refill filtered pipette tips has 9 mm spacing between each of the upper plurality of refill filtered pipette tips thereby allowing the upper filtered refill wafer to be compatible with a microtiter plate with 9 mm well center-to-center spacing.

In various embodiments of the method 600 the holes between the top portions of the lower plurality of refill filtered pipette tips are between 3 and 5 Millimeters (mm) in diameter.

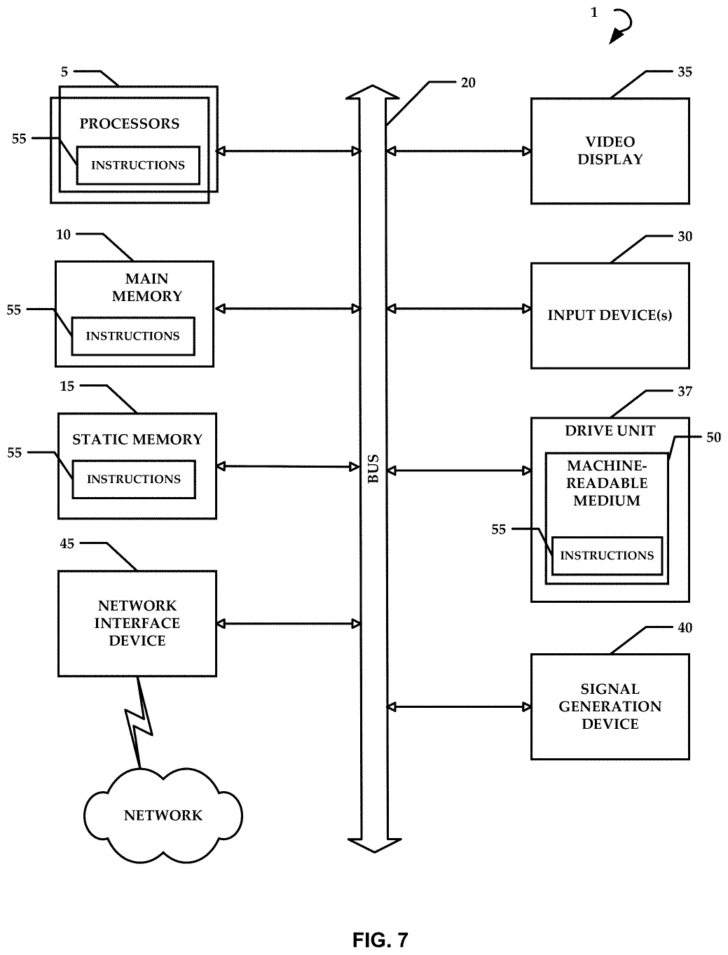

FIG. 7 is a schematic diagram of an example computing device that can be used to implement aspects of the present technology according to various embodiments. The example computer system 1 includes a processor or multiple processors 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processors 5 during execution thereof by the computer system 1. The main memory 10 and the processors 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Not all components of the computer system 1 are required and thus portions of the computer system 1 can be removed if not needed, such as Input/Output (I/O) devices (e.g., input device(s) 30). One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Bolt”) may be interchangeably used with its non-capitalized version (e.g., “bolt”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “mechanically connected,” etc., are used interchangeably herein to generally refer to the condition of being mechanically/physically connected. If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, extrusion, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

Additionally, components described as being “first” or “second” can be interchanged with one another in their respective numbering unless clearly contradicted by the teachings herein.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method for nesting refill filtered pipette tips to reduce storage space and plastic waste, the method comprising:
loading a lower filtered refill wafer comprising a lower plurality of refill filtered pipette tips into a nested filtered pipette tip rack so that the lower plurality of refill filtered pipette tips are easily loadable onto a pipette, the lower filtered refill wafer comprising the lower plurality of refill filtered pipette tips having holes between top portions of the lower plurality of refill filtered pipette tips; and
nesting an upper filtered refill wafer comprising an upper plurality of refill filtered pipette tips into the holes between the top portions of the lower plurality of refill filtered pipette tips, the nesting of the upper filtered refill wafer resulting in bottom portions of the upper plurality of refill filtered pipette tips being nested in the holes between the top portions of the lower plurality of refill filtered pipette tips thereby reducing storage space for the nested filtered pipette tip rack compared with storage space for a filtered pipette tip rack that is not nested.

2. The method according to claim 1, wherein the lower filtered refill wafer comprising the lower plurality of refill filtered pipette tips has 9 Millimeter (mm) spacing between each of the lower plurality of refill filtered pipette tips thereby allowing the lower filtered refill wafer to be compatible with a microtiter plate with 9 mm well center-to-center spacing; and
wherein the upper filtered refill wafer comprising the upper plurality of refill filtered pipette tips has 9 mm spacing between each of the upper plurality of refill filtered pipette tips thereby allowing the upper filtered refill wafer to be compatible with a microtiter plate with 9 mm well center-to-center spacing.

3. The method according to claim 1, wherein the holes between the top portions of the lower plurality of refill filtered pipette tips are between 3 and 5 Millimeters (mm) in diameter.

4. The method according to claim 1, wherein the lower plurality of refill filtered pipette tips of the lower filtered refill wafer and the upper plurality of refill filtered pipette tips of the upper filtered refill wafer have a same pipette volume.

5. The method according to claim 4, wherein the same pipette volume is at least one of 5 Microliters (μl), 10 μl, 15 μl, 20 μl, 50 μl, 100 μl, 200 μl, 500 μl, and 1000 μl.

6. A method for nesting refill filtered pipette tips to reduce storage space and plastic waste, the method comprising:
loading a lower filtered refill wafer comprising a lower plurality of refill filtered pipette tips into a nested filtered pipette tip rack so that the lower plurality of refill filtered pipette tips are easily loadable onto a pipette, the lower filtered refill wafer comprising the lower plurality of refill filtered pipette tips having holes between top portions of the lower plurality of refill filtered pipette tips;
aligning an upper filtered refill wafer comprising an upper plurality of refill filtered pipette tips in a same configuration as the lower filtered refill wafer comprising the lower plurality of refill filtered pipette tips;
rotating the upper filtered refill wafer comprising the upper plurality of refill filtered pipette tips one-hundred-and-eighty-degrees (180°) relative to the upper filtered refill wafer after the aligning of the upper filtered refill wafer and before loading the upper filtered refill wafer comprising the upper plurality of refill filtered pipette tips into the nested filtered pipette tip rack; and
nesting the upper filtered refill wafer comprising the upper plurality of refill filtered pipette tips into the holes between the top portions of the lower plurality of refill filtered pipette tips, the nesting of the upper filtered refill wafer resulting in bottom portions of the upper plurality of refill filtered pipette tips being nested in the holes between the top portions of the lower plurality of refill filtered pipette tips thereby reducing storage space for the nested filtered pipette tip rack compared with storage space for a filtered pipette tip rack that is not nested.

7. The method according to claim 6, wherein the lower filtered refill wafer comprising the lower plurality of refill filtered pipette tips has 9 Millimeter (mm) spacing between each of the lower plurality of refill filtered pipette tips thereby allowing the lower filtered refill wafer to be compatible with a microtiter plate with 9 mm well center-to-center spacing; and
wherein the upper filtered refill wafer comprising the upper plurality of refill filtered pipette tips has 9 mm spacing between each of the upper plurality of refill filtered pipette tips thereby allowing the upper filtered refill wafer to be compatible with a microtiter plate with 9 mm well center-to-center spacing.

8. The method according to claim 6, wherein the holes between the top portions of the lower plurality of refill filtered pipette tips are between 3 and 5 Millimeters (mm) in diameter.

9. The method according to claim 6, wherein the lower plurality of refill filtered pipette tips of the lower filtered refill wafer and the upper plurality of refill filtered pipette tips of the upper filtered refill wafer have a same pipette volume.

10. The method according to claim 9, wherein the same pipette volume is at least one of 5 Microliters (μl), 10 μl, 15 μl, 20 μl, 50 μl, 100 μl, 200 μl, 500 μl, and 1000 μl.

11. A system for nesting refill filtered pipette tips to reduce storage space and plastic waste, the system comprising:
a lower filtered refill wafer comprising a lower plurality of refill filtered pipette tips in a nested filtered pipette tip rack with the lower plurality of refill filtered pipette tips being easily loadable onto a pipette, the lower filtered refill wafer comprising the lower plurality of refill filtered pipette tips having holes between top portions of the lower plurality of refill filtered pipette tips; and
an upper filtered refill wafer comprising an upper plurality of refill filtered pipette tips nested into the holes between the top portions of the lower plurality of refill filtered pipette tips, the nesting of the upper filtered refill wafer resulting in bottom portions of the upper plurality of refill filtered pipette tips being nested in the holes between the top portions of the lower plurality of refill filtered pipette tips thereby reducing storage space for the nested filtered pipette tip rack compared with storage space for a filtered pipette tip rack that is not nested.

12. The system according to claim 11, wherein the lower filtered refill wafer comprising the lower plurality of refill filtered pipette tips has 9 Millimeter (mm) spacing between each of the lower plurality of refill filtered pipette tips thereby allowing the lower filtered refill wafer to be compatible with a microtiter plate with 9 mm well center-to-center spacing; and
wherein the upper filtered refill wafer comprising the upper plurality of refill filtered pipette tips has 9 mm spacing between each of the upper plurality of refill filtered pipette tips thereby allowing the upper filtered refill wafer to be compatible with a microtiter plate with 9 mm well center-to-center spacing.

13. The system according to claim 11, wherein the holes between the top portions of the lower plurality of refill filtered pipette tips are between 3 and 5 Millimeters (mm) in diameter.

14. The system according to claim 11, wherein the lower plurality of refill filtered pipette tips of the lower filtered refill wafer and the upper plurality of refill filtered pipette tips of the upper filtered refill wafer have a same pipette volume.

15. The system according to claim 14, wherein the same pipette volume is at least one of 5 Microliters (μl), 10 μl, 15 μl, 20 μl, 50 μl, 100 μl, 200 μl, 500 μl, and 1000 μl.

16. The system according to claim 11, wherein the lower filtered refill wafer comprising the lower plurality of refill filtered pipette tips having holes between top portions of the lower plurality of refill filtered pipette tips and the upper filtered refill wafer comprising the upper plurality of refill filtered pipette tips nested into the holes between the top portions of the lower plurality of refill filtered pipette tips comprise a nested filtered pipette tip stack.

17. The system according to claim 16, wherein the nested filtered pipette tip stack comprises a total of five filtered refill wafers.

18. The system according to claim 16, wherein the nested filtered pipette tip stack comprises a total of ten filtered refill wafers.

19. The system according to claim 18, wherein the nested filtered pipette tip stack comprises an 8 filtered pipette tip by 12 filtered pipette tip array.
